(19) United States
(12) Patent Application Publication
(10) Pub. No.: US 2018/0317132 A1
(43) Pub. Date: Nov. 1, 2018

(54) Bicasting Data to Wireless Terminal over At Least Two Air Interfaces

(71) Applicant: Nokia Solutions and Networks Oy, Espoo (FI)

(72) Inventors: Hans Thomas Hoehne, Helsinki (FI); Henri Markus Koskinen, Espoo (FI)

(21) Appl. No.: 15/772,230

(22) PCT Filed: Nov. 5, 2015
(86) PCT No.: PCT/EP2015/075810

§ 371 Date: Apr. 30, 2018

(51) Int. Cl. H04W 28/08; H04W 76/15; H04L 1/16; H04W 28/02; H04L 12/825

(52) U.S. Cl. CPC H04W 28/085; H04W 76/15; H04L 1/1671; H04L 2001/0097; H04W 28/0236; H04L 47/26; H04W 28/0226

(57) ABSTRACT

Data is bicasted to a wireless terminal over a wireless at least two air interfaces. Feedback on the data transferred over one of the air interfaces is obtained. An extent of future use of said one of said air interfaces to said wireless terminal at least in part may be determined on the basis of the obtained feedback. Feedback on the data obtained over at least one of the air interfaces is provided in response to bicasting of the data or in response to an indication sent to the wireless terminal.

### FIELD

The invention relates to bicasting data to a wireless terminal over at least two air interfaces.

### BACKGROUND

Wireless local area networks (WLANs) are being aggregated to Long Term Evolution (LTE) networks in Release 13 specifications developed by the 3rd generation partnership project. In order for the WLAN to support data transmission to user equipment (UE), the WLAN should have sufficient service availability. The service availability of WLAN can be negatively affected by high traffic load in the WLAN and low WLAN signal strength. In order to transfer data successfully to the UE over the WLAN, the service availability should be tested. However, testing the service availability prior to data transmission introduces delay in the delivery of data and reduces the total amount of served data traffic.

### BRIEF DESCRIPTION

Embodiments of the invention include methods, apparatuses, a mobile communications network, computer program and computer program product characterized by what is stated in the independent claims.

Some embodiments allow testing the capability of to deliver data to user equipment over an air interface without incurring delays to data transmission to the user equipment.

### BRIEF DESCRIPTION OF DRAWINGS

In the following the invention will be described in greater detail by means of preferred embodiments with reference to the attached drawings, in which

FIGS. 1a and 1b illustrate examples of a mobile communications network according to embodiments;

FIGS. 2 and 3 illustrate examples of methods according to embodiments;

FIG. 4 illustrates an example of a method for offloading traffic according to an embodiment;

FIG. 5 illustrates an example for implementing feedback according to an embodiment;

FIGS. 6 and 7 illustrate examples of feedback according to embodiments; and

FIG. 8 illustrates a block diagram of an apparatus according to an embodiment.

### DETAILED DESCRIPTION

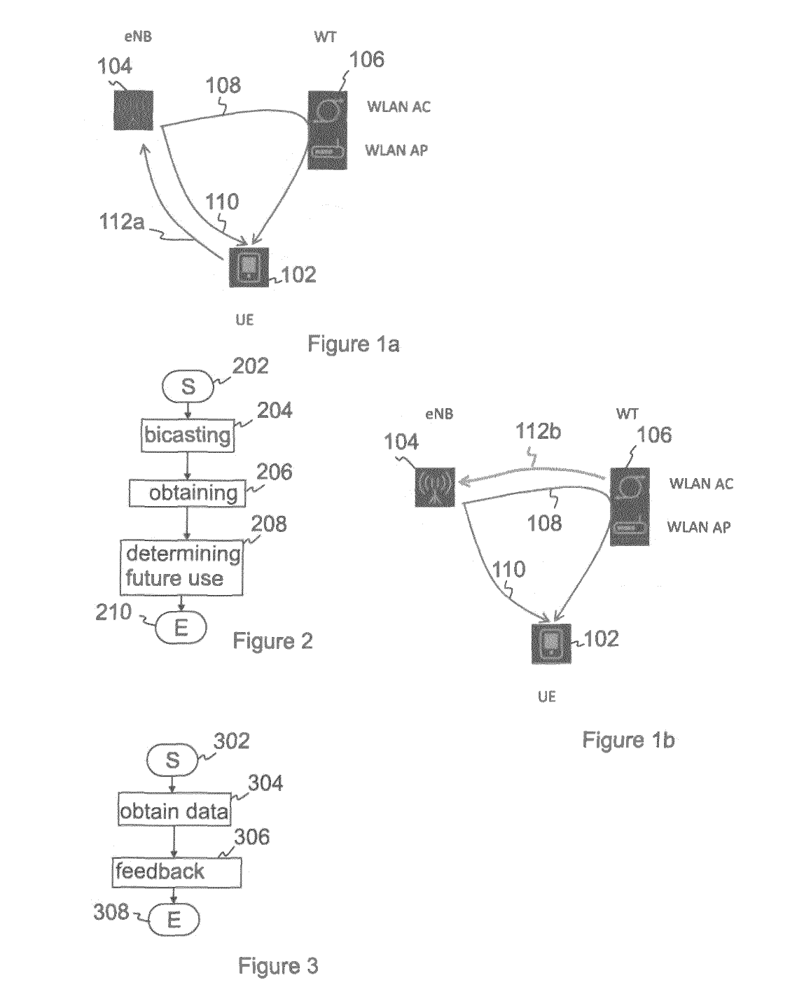

FIGS. 1a and 1b illustrate examples of a mobile communications network according to embodiments. The mobile communications network may comprise a wireless local area network (WLAN) and a cellular radio network (CRN) capable of communicating traffic to at least one recipient device 102. The recipient device may be capable of wireless radio frequency communications with the mobile communications network and referred to a wireless terminal. The WLAN and the CRN may connect to wireless terminals over air interface connections. The air interface connections may be wireless radio frequency connections. Connections between the CRN and the WLAN may be implemented by wired data connections, for example based on the Internet Protocol. The WLAN may be used for offloading traffic from the CRN to the WLAN. In offloading the traffic is directed to the UE via the WLAN. The wireless terminal may be referred to as user equipment (UE). The UE may have a subscription to the mobile communications network. The subscription authorizes the UE to obtain services of the mobile communications network via the WLAN and the CRN. Typically the WLAN operates on unlicensed radio frequency bands such as the radio frequency bands reserved for Industrial Scientific and Medical use. The CRN typically operates on licensed radio frequency bands, whose use is restricted to the licensee(s). The services of the mobile communications network may comprise telecommunications services provided by the mobile communications network. The mobile communications network may be operated by a network operator. Telecommunications services provided to the subscribers of the operator's network may allow the UE to access services of other service providers, i.e. third party service providers, outside the operator's network. These services may utilize the operator's network as a platform for delivering the third party services.

It should be appreciated that also other technologies for radio frequency communications than the WLAN and the CRN may be used to implement the air interfaces of the mobile communications network. Accordingly, the air interfaces may provide different communications technologies for connecting the UE to the mobile communications network. The communications technologies of the different air interfaces may comprise communications protocols that are specific to each air interface. In one example the air interfaces may have differences on a physical layer of the air interfaces, for example the air interfaces may have different radio frequency bands for communications. Other protocol layers, for example higher layer protocols such, may also be different. In the following description the air interfaces may be referred to as a WLAN interface and a CRN interface.

The CRN may comprise one or more radio access nodes 104 for serving the UE. A radio access node may serve as a CRN interface for the UE to the mobile communications network. In this way the UE may access the mobile communications network via the radio access node, when the UE is within a coverage area of the radio access node. A radio access node may include one or more cells that each has a coverage area. Accordingly, the coverage area of the radio access node may be formed by the coverage areas if eth cells. Thereby, one or more cells of the radio access nodes may serve as CRN interfaces for the UE.

The WLAN may comprise one or more WLAN Access Points (APs) 106. The WLAN APs may serve as radio access nodes in the WLAN. Accordingly, the, the UE may access the mobile communications network via a WLAN AP, when the UE is within a coverage area of the WLAN AP. At least one of the WLAN APs may serve as an interface, i.e. WLAN interface to the CRN. The WLAN interface may be connected to the radio access node of the CRN and referred to a WLAN termination (WT). In the CRN the radio access node of the CRN connected to the WLAN may manage resource of the WLAN. The WT may implement WLAN Access Control (AC) functionality for controlling access of UE to the mobile communications network via the WLAN. The WLAN AC may support the resource management of the WLAN by the radio access node of the CRN.

The WT may be connected directly to the UE, whereby the WLAN air interface of the UE may terminate at the WT. It should be appreciated that the WLAN may comprise one or more further WLAN APs in addition to the WT. When a WLAN AP is not operating as WT but only terminating the air interface of the UE, the WLAN AP may be connected to the WT for connecting the UE to the CRN. In such a case the WT may operate as WLAN interface towards the CRN and the WLAN AP terminating the air interface connection may operate as WLAN interface towards the UE.

The WLAN may be connected to the CRN via an adaptation layer. In one example the adaptation layer may define one or more messages and/or procedures between the CRN and WT for adaptation of the WLAN to the CRN. Accordingly, the adaptation layer may be a protocol layer that may be implemented in entities of the CRN, for example a radio access node, and the WLAN, for example the WT. The adaptation layer may also ensure that CRN specific data flow information is mapped onto the equivalent WLAN parameters, as for instance QoS indicators are translated to WLAN access classes. The adaptation layer may also encapsulate CRN specific data flow information as for instance bearer ID or flow ID such that it can traverse the WLAN network. The adaptation may be implemented in both the WLAN and CRN. In the CRN, the adaptation layer may be implemented in an entity capable of originating bicasted traffic to the UE. In the CRN the originating entity may be the radio access node of the CRN. In the WLAN the adaptation layer may be implemented in the WT. An information element set in the adaptation layer may be an information element a message from the CRN to the WLAN.

Bicasted traffic to the UE may refer to traffic that is duplicated over the WLAN and CRN interfaces. Accordingly, the bicasted traffic may be transmitted to the UE over bot the WLAN air interface and the CRN air interface.

Traffic to the UE may be data for example user plane data. Traffic may be communicated between the UE and the mobile communications network over both the WLAN and the CRN. The traffic may be uplink traffic and/or downlink traffic. In an example, the downlink traffic 108 to the UE may be directed to the UE from the radio access node of the CRN over the WLAN interface. The downlink traffic 110 may also be directed to the UE directly from the radio access node of the CRN. In an example of uplink traffic 112a, 112b, the UE may send traffic, for example feedback to the radio access node. In the example of FIG. 1a, the feedback may be sent to the radio access node of the CRN directly over the air interface to the CRN. In the example of FIG. 1b, the feedback may be sent to the radio access node of the CRN over the air interface to the WLAN, where the feedback may be delivered to the radio access node over the connection between the CRN and the WLAN provided for example by the WT.

The CRN may be a Long Term Evolution (LTE) network according to 3^{rd} Generation Partnership Project (3GPP) Release 12 or later Specifications. The CRN may be also a network according to the upcoming 5G standard specified by 3GPP. There the CRN may be a physical network element, or it may be a virtualized software entity. The WLAN may be a WLAN according to the IEEE 802.11 family of standards. In the context of the Release 12 specifications, the air interface between the radio access node of the CRN and the UE may be implemented as Uu interface and the air interface between the WLAN and the UE may be implemented by Xw interface. User plane of the Xw interface may be referred to as Xw-U and control plane of the Xw interface may be referred to as Xw-AP. The radio access node of the CRN may implement an adaptation layer such that traffic such as data may be bicasted over the Uu and the Xw-U to the UE. Depending on implementation, the naming of the radio access nodes and UE may vary. Examples of the radio access nodes of the CRN may comprise a base station, NodeB, a Radio Network Controller (RNC) and Evolved NodeB (eNB), or future 5G-NodeB or 5G controller.

FIGS. 2 and 3 illustrate examples of methods according to embodiments. The methods allow testing the capability of WLAN to deliver data to UE without incurring delays to data transmission to the UE. FIG. 2 illustrates a method for an entity originating traffic towards UE in a mobile communications network. The entity originating traffic may be a radio access node of the CRN in a mobile communications network, for example the mobile communications network of FIG. 1.

The method may start 202, when the UE is within a coverage area of the radio access node of the CRN and capable to receive data from the mobile communications network. The radio access node may have traffic, for example data, is destined to the UE. It should be appreciated that in order for the UE to receive data from the mobile communications network, the UE may be in the coverage area of the radio access node of the CRN, a WLAN AP, or in the coverage areas of both the radio access node of the CRN and the WLAN AP. The UE may be attached to the mobile communications network, whereby the UE may be allocated capacity for data transfers.

Data may be bicasted 204 to UE over at least two air interfaces according to different radio frequency communications technologies. The air interfaces may comprise a WLAN interface and a CRN interface. More than two air interfaces may be implemented by other technologies for radio communications. Examples of the other technologies comprise Bluetooth and 5G.

In bicasting, data destined to the UE may be duplicated over the air interfaces such as the WLAN and the CRN interfaces. Accordingly, the data may be transmitted to the UE over an air interface to the CRN provided by the radio access node of the CRN and over the air interface to the WLAN provided by the WLAN AP. Feedback on the data transferred over one of the air interfaces may be obtained 206. The feedback may be obtained for the data transferred over the wireless local area network. In this way the success or failure of the data transfer over the WLAN interface may be determined. The feedback may be obtained from the UE over any of the air interfaces used for bicasting 204. Feedback may be obtained directly from the UE over the air interface to the CRN, according to the example illustrated in FIG. 1a by arrow 112a. The feedback may be also obtained from the WLAN AC or WLAN AP according to the example illustrated in FIG. 1b by arrow 112b. The feedback, when obtained from the WLAN AC, may inform the radio access node of the CRN, such as eNB, about the amount of data that has been already transmitted. The UE may perform flow control, whereby feedback on reception of data over the WLAN air interface may be sent from the UE. The feedback may be referred to FC feedback. The FC feedback may be sent after a first successfully received data and/or after successfully received data after the first data. The first successfully received data may be received after bicasting 204 of data has started. The data may be data packets, for example data packets carrying user data such as Packet Data Convergence Protocol (PDCP) packets.

The feedback may be sent for example in a Packet Data Convergence Protocol (PDCP) status report, PDCP acknowledgement (ACK), a signalling indication over an Xw interface, and/or in a Radio Resource Control (RRC) message.

In an embodiment, the feedback may comprise information indicating a reception of data transferred over the WLAN interface. The data received over the wireless local area network interface may be preferably successfully received before feedback is sent for indicating reception of the data. However, it may be that the received data may have errors. It may be possible to send feedback also for received data even if includes errors. However, defining that feedback is sent for data that is successfully received enables to identify a functional WLAN connection on the basis of the feedback.

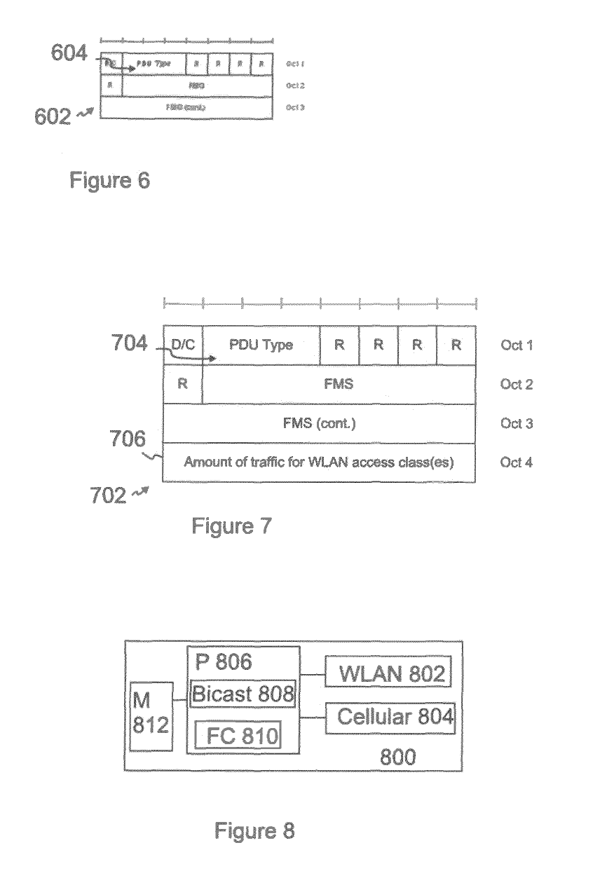

In an embodiment, the feedback may comprise information indicating at least one sequence number of data packet transferred over the wireless local area network interface. The sequence number may indicate the sequence number of the first data packet transferred over the WLAN interface. The first data packet may be received after bicasting 204 of data has started. The first data packet may preferably be a successfully received data packet as explained above. On the other hand the sequence number may indicate a sequence number of an out-of-sequence data packet. The out-of-sequence data packets may be received after the first data packet. The sequence number of the first data packet may be included for example in a Packet Data Convergence Protocol (PDCP) status report according to FIG. 6 or 7. The sequence number of out-of-sequence data packets may be included in a PDCP acknowledgement (ACK).

Accordingly, the feedback may comprise the first sequence number and/or further out-of-band sequence numbers. Various messages, such as PDCP status report, PDCP ACK, a signalling indication over an Xw interface and RRC message, may be used to carry the first SN and the out-of-sequence SNs. A single message may comprise more than one sequence numbers. Having the first SN and the out-of-sequence SNs may facilitate deciding when to stop bicasting data to the UE and start unicasting data to the UE, and whether the unicasting should be performed over the WLAN interface or the CRN interface.

In an embodiment the feedback may comprise information indicating an amount of data transferred over the wireless local area network interface in a time period. The amount of data transferred over the wireless local area network interface in a time period may be a data rate transferred over the wireless local area network interface.

In an embodiment, the feedback may comprise information indicating a sequence number of data packet transferred over the wireless local area network interface.

An extent of future use of the air interfaces to the UE may be determined 208 at least in part on the basis of the obtained 206 feedback.

The extent of future use may comprise whether traffic such as data should be transmitted to the UE over the air interface or not. The obtained feedback may be used to determine the extent of future use together with other criteria. Examples of the other criteria comprise amount of data destined to UE and whether any data is destined to UE at all.

In an embodiment an extent of future use may comprise determining to unicast data to the UE over the wireless local area network or the cellular radio network interface on the basis of the obtained feedback. When unicasting is started, the bicasting 204 may be stopped and data may be transmitted to the UE via the WLAN or via the CRN. Unicasting over the WLAN or the CRN may be determined on the basis of checking the feedback. If feedback has been received, the feedback may be processed for determining whether the data may be unicast over the WLAN interface or the CRN interface. If the feedback indicates that data may be delivered to the UE via the WLAN, the bicasting may be stopped and data may be unicast to the UE via the WLAN. If the feedback indicates that data may is not successfully delivered to the UE via the WLAN, the bicasting may be stopped and data may be unicast to the UE via the CRN.

The method may end 210 after the feedback has been utilized in determining whether data to the UE is transmitted via the WLAN interface or CRN interface.

FIG. 3 illustrates a method for an entity receiving traffic in a mobile communications network. The entity receiving traffic may be UE, for example the UE in the mobile communications network of FIG. 1. The method may start, when the UE is within a coverage area of the radio access node of the CRN and capable to receive data from the mobile communications network. The UE may be attached to the mobile communications network, whereby the UE may be allocated capacity for data transfers.

Data may be obtained 304 to the UE over at least one of at least two air interfaces. The air interfaces may be according to different radio frequency communications technologies. The air interfaces may be for example a wireless local area network interface and over a cellular radio network interface.

Feedback on the obtained 304 data over at least one of the air interfaces may be provided 306 in response to bicasting of the data or in response to an indication sent to the wireless terminal.

The bicasting of data to the UE may be performed as described in step 204 with FIG. 2. The bicasting may be determined in the UE from the received data. The received data may be inspected by the UE. The UE may realize that data is being bicasted, simply by looking at PDCP SNs in its buffer. The UE may conclude on the basis of the PDCP SNs that it should provide a report on the WLAN specific traffic. The report, i.e. feedback, on the WLAN specific traffic may be provided additionally to any other feedback, for example normal PDCP feedback. Alternatively, it is possible that the UE may see the indication in the WLAN data and determine to provide the WLAN specific feedback.

The feedback of data sent over a wireless local area network may be provided in response to an indication sent by the radio access node of the CRN. The indication may be sent for example via an adaptation layer between the WLAN and the CRN. An example of the indication utilizing the adaptation layer is described in FIG. 5. The FC may comprise determining successful and/or failed data transmissions over the WLAN interface. Information indicating the determined successful and/or data transmissions may be caused to be transmitted to the entity, such as the radio access node, originating the bicasted traffic in the CRN.

The method may end 308 after the flow control of the bicasted data has been started such that information of the success and/or failure of the data transmission over the WLAN interface may be obtained for determining whether data to the UE is transmitted via the WLAN interface or CRN interface.

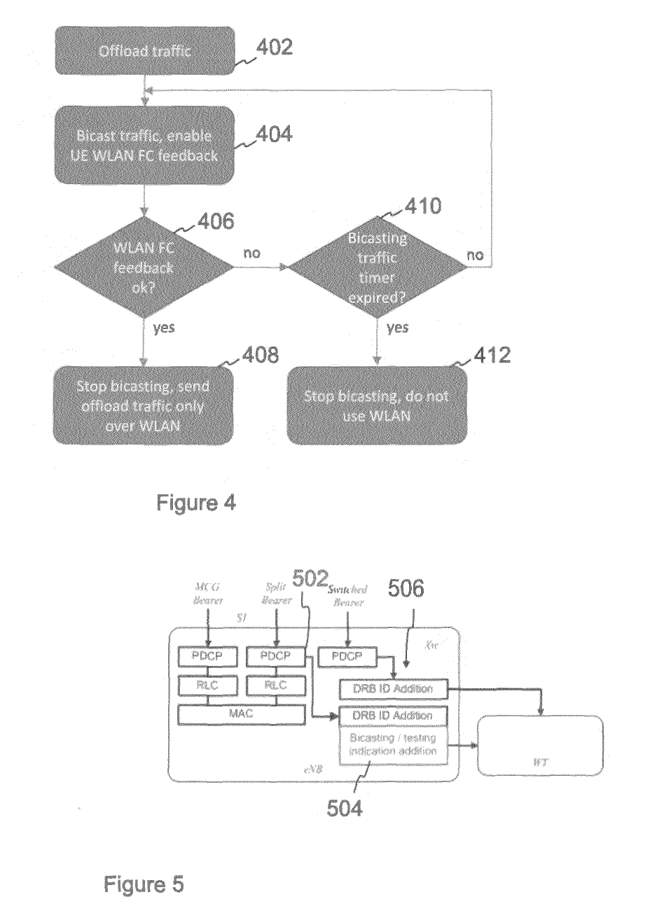

FIG. 4 illustrate an example of a method for offloading traffic according to an embodiment. The method provides testing the capability of the WLAN to deliver data to UE before without incurring delays to data transmission to the UE. The method of FIG. 4 may be performed by an entity originating traffic towards UE in a mobile communications network. The entity originating traffic may be a radio access node of the CRN in a mobile communications network, for example the mobile communications network of FIG. 1.

The method may be performed, when traffic, for example data, is destined to the UE in the radio access node of the CRN. The method may be performed until bicasting is stopped 408, 412.

A decision to offload 402 traffic towards the UE over the WLAN interface may be made. The decision may be made on the basis of available capacity to serve the traffic. The decision may be made on the basis of achievable quality of service parameters such as throughput and delay; the knowledge on the achievable quality of service is obtained through the feedback obtained from the UE or the WLAN AC. The offloading may comprise directing traffic destined to the UE to the WLAN interface. The offloading may be performed, when the UE is within a coverage area of the radio access node of the CRN and a WLAN AP and capable to receive data from the radio access node of the CRN and the WLAN AP. The UE may be attached to the mobile communications network via both the WLAN AP and the radio access node of the CRN, whereby the UE may be allocated capacity for data transfers in both the WLAN and the CRN.

Data may be bicasted 404 to the UE over the WLAN interface and the CRN interface in response to the decision to offload traffic. In bicasting data, the offloaded traffic may be duplicated for transmission over the WLAN interface and the CRN interface. FC specific to the data traveling over the WLAN interface may be performed on the bicasted data such that feedback may be received from the UE. The UE may start providing FC feedback in response to bicasting of the data or in response to an indication sent to the UE as is described in step 306 in FIG. 3.

It should be appreciated that since the decision to offload 402 traffic is made, bicasting 404 is intended as a temporary phase for testing the WLAN interface capabilities, before data to UE is unicast 408 over the WLAN interface or data to UE is unicast 412 over the CRN interface and offloading 402 to WLAN may be cancelled.

It should be appreciated that the bicasted 404 data may be received by the UE over the WLAN interface and/or over the CRN interface. Accordingly, in bicasting the UE may be allocated resources for the data transfers on both the WLAN and the CRN air interfaces. Success of the data transfers may depend for example on signal strengths of the WLAN and the CRN, and available capacity for serving the data transmissions over the WLAN interface and the CRN interface. Accordingly, the data transfers to the UE may fail on either or both the WLAN interface and the CRN interface and it may be even that no data is transmitted on the WLAN interface and/or the CRN interface, although the originating entity is bicasting data.

If 406 the feedback indicates that data has been successfully received at the UE over the WLAN interface, bicasting may be stopped 408, and the data transfer may be continued as a unicast data transfer over the wireless local area network interface.

If 406 the feedback indicates unsuccessful data transfer over the wireless local area network interface, the bicasting may be stopped 412, and the data transfer may be continued as a unicast data transfer over the cellular radio network interface.

In an embodiment, when 406 the feedback indicates unsuccessful data transfer over the wireless local area network interface the bicasting may be stopped on an expiry of a timer. The timer may be set from the beginning of the bicasting 404 for example. Accordingly, the bicasting may be stopped if 410 the timer has expired and the feedback indicates unsuccessful data transfer over the wireless local area network interface. The timer may be set to expire after a time period. The time period may be an adjustable parameter.

If 410 the timer has not been expired the bicasting 404 may be continued.

FIG. 5 illustrates an example for implementing feedback according to an embodiment. UE may be caused to send feedback for bicasted data by a PDCP protocol entity 502 setting an information element 504 in an adaptation layer 506. The adaptation layer may implement an interface, for example Xw interface, between WLAN and CRN. In the WLAN the adaptation layer may be implemented in WT and in the CRN in a radio access node. The information element may comprise information indicating that data is bicasted to the UE over WLAN and CRN interfaces. The information element may comprise criteria for the UE. The criteria may define when the UE should send WLAN-specific feedback, i.e. feedback on data transferred over the WLAN interface. The criteria may for instance specify to only provide feedback when a certain amount of data is received within a certain amount of time. The information element may be sent to the UE in a message indicating an identifier of the bearer that carries the bicasted data. The message may be referred to a signalling indication. The UE may start FC on the basis of the information element for sending FC feedback. The message may be a message to a WT for adding a bearer to the WLAN in a procedure 508 of the adaptation layer. The bearer carrying data that is bicasted over a WLAN interface and a CRN interface may be referred to as split bearer. The PDCP protocol entity may be implemented in a radio access node of the CRN, e.g. eNB.

The WT may obtain the message and determine whether an information element in the message is set to indicate that feedback on data transferred over the WLAN interface should be sent from the UE to the radio access node of the CRN. Feedback should be sent, when the information element in the message indicates that data is bicasted to the UE over WLAN and CRN interfaces. The feedback may be sent in a signalling indication over an Xw interface, a PDCP ACK, PDCP status report or in an RRC message.

FIGS. 6 and 7 illustrate examples of feedback according to embodiments. The feedback may be sent from a WLAN, for example from a WT, or from a UE. The feedback sent from the WT may refer to PDU sequence numbers over the interface between the eNB and the WT, instead of PDCP SNs between the UE and the eNB. FIGS. 6 and 7 show examples, where the feedback may be a packet data convergence protocol (PDCP) status report 602, 702 having a Protocol Data Unit (PDU) type field 604, 704 indicating that the PDCP status report holds a PCDP protocol data unit (PDU) sequence number (SN). In an example the PDCP PDU type is a three bit field, where the presence of the PDCP PDU SN in the PDCP PDU may be indicated by a bit sequence ‘111’. Other bit sequence of het PDCP PDU type field may be as follows: ‘000’ indicating PDCP status report, ‘001’ header-compression feedback packet. Further bit sequences may be reserved for other uses. The PDCP PDU type field may be in a first octet of the PDCP status report.

In FIG. 7 the PDCP status report may comprise information indicating an amount of data 706 transferred over the wireless local area network interface in a time period. The information of the amount of data may be in the fourth octet of the PDCP status report.

In FIGS. 6 and 7 the feedback has been described in a PDCP status report. However, it should be appreciated that the feedback may be included in other messages as well. In one example the feedback may be included in a PDCP acknowledgement (ACK), a signalling indication over an Xw interface or an RRC message.

FIG. 8 illustrates a block diagram of an apparatus according to an embodiment. The apparatus 800 may comprise a processor 806 and a memory 812. The memory may store instructions to be executed by the processor. The at least one memory and the instructions are configured to, with the at least one processor, cause the apparatus at least to cause a method according to an embodiment.

The processor may be implemented in more than one unit comprising a bicasting unit 808 and a FC unit 810. The functionality of the bicasting unit and the FC unit may be different, when the apparatus is UE, a radio access node or a part of the apparatus, for example a data processing unit or a module.

The apparatus may comprise a WLAN interface 802 and a CRN interface. The WLAN and CRN interfaces provide communications of information, for example data and/or messages in the WLAN and the CRN. Examples of the data and/or messages comprise UE data, feedback and adaptation layer messages.

In a radio access node, or a part of the radio access node the bicasting unit 808 may generate data for bicasting to UE over a wireless local area network interface 802 and over a cellular radio network interface 804. The FC unit may process, e.g. obtain, FC feedback on the data transferred over the wireless local area network. The bicasting unit and the FC unit may be connected such that the bicasting unit and the FC unit may unicasting data to the UE over the wireless local area network or the cellular radio network interface may be determined on the basis of the obtained flow control feedback.

In UE, or a part of the UE the bicasting unit 808 may obtain data to UE over at least one of a wireless local area network interface 802 and over a cellular radio network interface 804. The FC unit may perform flow control of data to UE over a wireless local area network interface in response to bicasting data to the UE over the wireless local area network interface and over a cellular radio network interface. The bicasting unit and the FC unit may be connected such that bicasting data to the UE causes performing FC.

According to an embodiment, an apparatus such as UE, a radio access node or a part of the apparatus, for example a data processing unit or a module, may comprise processing means configured to carry out any of the embodiments of FIGS. 2, 3 and 4. The processing means may be formed by the at least one processor 806 and the memory 812. The processing means may be a computer or a part of a computer.

In an embodiment there is provided a computer program comprising computer program code for execution on a computer to cause a method according to an embodiment, when said product is run on a computer. The computer program may be embodied on a computer-readable storage medium.

In an embodiment there is provided a computer program product for a computer, comprising a computer program according to an embodiment.

An embodiment concerns a computer program embodied on a computer-readable storage medium, the computer program comprising program to execute a process comprising a method according an embodiment.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer-readable storage medium. The computer-readable storage medium may be a computer program distribution medium readable by a computer or a processor. The computer-readable storage medium may be, for example but not limited to, a record medium, computer memory, read-only memory, electrical carrier signal, telecommunications signal, and software distribution package, for example.

The various embodiments may be applied to communications networks and communications systems, where data may be transmitted between devices such as UE or a terminal and the network infrastructure such as a radio access node or a data processing unit. The techniques described herein may be implemented by various means so that an apparatus implementing one or more functions of data processing unit, radio access node of the CRN or UE described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. A hardware implementation may be through one or more circuits, for example Application Specific Circuits (ASICs). For a firmware or software, implementation can be through modules (e.g., procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

It will be obvious to a person skilled in the art that, as the technology advances, the inventive concept can be implemented in various ways. The invention and its embodiments are not limited to the examples described above but may vary within the scope of the claims.

1. A method comprising
bicasting data to a wireless terminal over at least two air interfaces;
obtaining feedback on the data transferred over one of the at least two air interfaces; and
determining an extent of future use of said one of the at least two air interfaces to the wireless terminal at least in part on the basis of the obtained feedback.

2. The method according to claim 1, further comprising:
unicasting data to the wireless terminal over at least one of the at least two air interfaces.

3. A method comprising:
obtaining data to a wireless terminal over at least one of at least two air interfaces; and
providing feedback on the data obtained over at least one of the at least two air interfaces in response to bicasting of the data or in response to an indication sent to the wireless terminal.

4. The method according to claim 3, wherein data is bicasted in response to a decision to offload traffic to at least one of the at least two air interfaces.

5. The method according to claim 3, wherein if the feedback indicates successful data transfer over one of the at least two air interfaces, the bicasting is stopped, and the data transfer is continued as unicast data transfer over the one of the at least two air interfaces.

6. The method according to claim 3, wherein if the feedback indicates unsuccessful data transfer over one of the at least two air interfaces, the bicasting is stopped, and the data transfer is continued as unicast data transfer over another air interface.

7. The method according to claim 3, wherein the sending of said feedback by the wireless terminal is caused by a signalling indication sent to the wireless terminal.

8. The method according to claim 7, wherein the signalling indication sent to the wireless terminal is sent over a wireless local area network interface, and contains criteria for sending feedback from the wireless terminal.

9. The method according to claim 3, wherein the feedback comprises information indicating a reception of data transferred over one of the at least two air interfaces.

10. The method according to claim 3, wherein the feedback comprises information indicating a sequence number of data packet transferred over one of the at least two air interfaces.

11. The method according to claim 3, wherein the feedback comprises information indicating a data rate transferred over one of the at least two air interfaces.

12. The method according to claim 3, wherein the flow control feedback comprises at least one of a packet data convergence protocol PDCP control packet data unit, packet data convergence protocol PDCP acknowledgement, a signalling indication over an Xw interface and a radio resource control RRC message.

13. The method according to claim 3, wherein the at least two air interfaces are according to different radio frequency communications technologies.

14. The method according to claim 3, wherein the at least two air interfaces comprise a wireless local area network interface and a cellular radio network interface.

15. An apparatus comprising at least one processor, and
at least one non-transitory memory for storing instructions to be executed by the processor, wherein
the at least one non-transitory memory and the instructions are configured to, with the at least one processor, cause the apparatus at least to:
bicast data to a wireless terminal over at least two air interfaces;
obtain feedback on the data transferred over one of the at least two air interfaces; and
determine an extent of future use of said one of the at least two air interfaces to the wireless terminal at least in part on the basis of the obtained feedback.

16. The apparatus according to claim 15, wherein the apparatus is one of a wireless terminal, a radio access node of a cellular radio network, a data processing unit for the wireless terminal, and a data processing unit for a radio access node of the cellular radio network.

17. (canceled)

18. (canceled)

19. (canceled)

20. The method according to claim 1, wherein data is bicasted in response to a decision to offload traffic to at least one of the at least two air interfaces.

21. The method according to claim 1, wherein if the feedback indicates successful data transfer over one of the at least two air interfaces, the bicasting is stopped, and the data transfer is continued as unicast data transfer over the one of the at least two air interfaces.

22. A computer program product embodied on a non-transitory computer-readable medium in which a computer program is stored that, when being executed by a computer, is configured to provide instructions for:
bicasting data to a wireless terminal over at least two air interfaces;
obtaining feedback on the data transferred over one of the at least two air interfaces; and
determining an extent of future use of said one of the at least two air interfaces to the wireless terminal at least in part on the basis of the obtained feedback.

23. The apparatus according to claim 15, wherein data is bicasted in response to a decision to offload traffic to at least one of the at least two air interfaces.
